(19) United States
(12) Patent Application Publication
(10) Pub. No.: US 2016/0155364 A1
(43) Pub. Date: Jun. 2, 2016

(54) SURGICAL TRAINING AND IMAGING BRAIN PHANTOM

(71) Applicants: Cameron PIRON, Toronto (CA); Joshua RICHMOND, Toronto (CA); William LAU, Toronto (CA); Sheryl THINGVOLD, Toronto (CA)

(72) Inventors: Cameron Piron, Toronto (CA); Joshua Richmond, Toronto (CA); William Lau, Toronto (CA); Sheryl Thingvold, Toronto (CA)

(21) Appl. No.: 14/903,807

(22) PCT Filed: Jul. 10, 2014
(86) PCT No.: PCT/CA2014/050659

§ 371 Date: Jan. 8, 2016

Related U.S. Application Data
(60) Provisional application No. 61/845,256, filed on Jul. 11, 2013.
(60) Provisional application No. 61/900,122, filed on Nov. 5, 2013.

(51) Int. Cl. G09B 23/30; B29C 41/52; B29C 41/02; G09B 23/28; B29C 33/38

(52) U.S. Cl. CPC G09B 23/30; G09B 23/286; B29C 33/3835; B29C 33/3892; B29C 41/02; B29C 41/52; B29K 2029/04

(57) ABSTRACT

A brain phantom is disclosed which includes an anatomically correct structure with a life-like sulci outer brain structure. The phantom is made of materials that mimic one or both of biomechanical and imaging properties of the human brain. The phantom may be a single phantom or it may be a kit including a biomechanical phantom and a separate imaging phantom. The imaging phantom includes structures which mimic white brain tracks or bundles which can be observed using DTI, and can include a post production DTI image to allow practitioners to practice imaging techniques on in addition to practicing surgical techniques.

### CROSS-REFERENCE TO RELATED U.S APPLICATIONS

This application claims priority to U.S. Provisional Application No. 61/845,256, titled “SURGICAL TRAINING AND IMAGING BRAIN PHANTOM” and filed on Jul. 11, 2013, the entire contents of which are incorporated herein by reference.

This application claims priority to U.S. Provisional Application No. 61/900,122, titled “SURGICAL TRAINING AND IMAGING BRAIN PHANTOM” and filed on Nov. 5, 2013, the entire contents of which are incorporated herein by reference.

### FIELD

The present disclosure relates to models of the mammalian head and brain. More particularly, the present disclosure relates to models or phantoms of the mammalian head and brain for training and/or simulation of medical procedures, such as training with different types of imaging modalities and training for invasive surgical procedures to mention just a few.

### BACKGROUND

In the field of medicine, imaging and image guidance are a significant component of clinical care. From diagnosis and monitoring of disease, to planning of the surgical approach, to guidance during procedures and follow-up after the procedure is complete, imaging and image guidance provides effective and multifaceted treatment approaches, for a variety of procedures, including surgery and radiation therapy. Targeted stem cell delivery, adaptive chemotherapy regimes, and radiation therapy are only a few examples of procedures utilizing imaging guidance in the medical field.

Advanced imaging modalities such as Magnetic Resonance Imaging (“MRI”) have led to improved rates and accuracy of detection, diagnosis and staging in several fields of medicine including neurology, where imaging of diseases such as brain cancer, stroke, Intra-Cerebral Hemorrhage (“ICH”), and neurodegenerative diseases, such as Parkinson's and Alzheimer's, are performed. As an imaging modality, MRI enables three-dimensional visualization of tissue with high contrast in soft tissue without the use of ionizing radiation. This modality is often used in conjunction with other modalities such as Ultrasound (“US”), Positron Emission Tomography (“PET”) and Computed X-ray Tomography (“CT”), by examining the same tissue using the different physical principals available with each modality. CT is often used to visualize boney structures, and blood vessels when used in conjunction with an intra-venous agent such as an iodinated contrast agent. MRI may also be performed using a similar contrast agent, such as an intra-venous gadolinium based contrast agent which has pharmaco-kinetic properties that enable visualization of tumors, and break-down of the blood brain barrier. These multi-modality solutions can provide varying degrees of contrast between different tissue types, tissue function, and disease states. Imaging modalities can be used in isolation, or in combination to better differentiate and diagnose disease.

In neurosurgery, for example, brain tumors are typically excised through an open craniotomy approach guided by imaging. The data collected in these solutions typically consists of CT scans with an associated contrast agent, such as iodinated contrast agent, as well as MRI scans with an associated contrast agent, such as gadolinium contrast agent. Also, optical imaging is often used in the form of a microscope to differentiate the boundaries of the tumor from healthy tissue, known as the peripheral zone. Tracking of instruments relative to the patient and the associated imaging data is also often achieved by way of external hardware systems such as mechanical arms, or radiofrequency or optical tracking devices. As a set, these devices are commonly referred to as surgical navigation systems.

Since image-guided surgical procedures are complex in nature and the risk associated with use of such procedures in the brain is very high, the surgical staff must often resort to performing a simulated rehearsal of the entire procedure. Unfortunately, the tools and models that are currently available for such simulated rehearsal and training exercises typically fail to provide a sufficiently accurate simulation of the procedure.

### SUMMARY

An embodiment provides a complimentary head phantom kit, comprising: complimentary head phantom kit, comprising:

a) a first imaging head phantom including mammalian brain anatomical mimics constructed of materials selected on the basis of being imageable with one or more imaging technique;

b) at least a second biomechanical head phantom including mammalian brain anatomical mimics constructed of one or more materials selected on the basis that said one or more materials mimic one or more biomechanical properties of a mammalian head; and

c) said first imaging head phantom and said at least a second biomechanical head phantom being registered together, wherein one or more acquired images taken of said first imaging head phantom using said at least one imaging technique are registered with said at least a second biomechanical phantom, by ensuring that features in the one or more acquired images from the imaging phantom are geometrically correlated to corresponding features in the biomechanical head phantom, for providing navigation of said second biomechanical head phantom during surgical training procedures.

There is also provided a method of producing a brain phantom including deep sulci, comprising:

acquiring an image of a human brain;

using said image to 3D-print an anatomically accurate model of the brain with deep sulci emulating the human brain;

applying a flexible mold material to an outer surface of the model of the brain and after the mold material has set to form a brain mold, releasing the brain mold from the model of the brain;

placing the brain mold into a rigid outer shell and filing the mold with a liquid precursor of a brain material mimic, optionally embedding in the liquid precursor one or more mimics for one or more structural brain features;

inducing the liquid precursor to set to form an anatomically correct brain phantom in one piece with deep sulci; and

releasing the brain phantom from the brain mold.

There is also provided a mammalian brain phantom, comprising:

a simulated mammalian brain including sulci topographical structure on an outer surface thereof, said a simulated mammalian brain having a composition which,
upon being imaged by an imaging technique, one or more structural features of the simulated mammalian brain are discernable in an image taken by the imaging technique; and
exhibits one or more biomechanical properties comparable to one or more associated biomechanical properties of a real mammalian brain.

### BRIEF DESCRIPTION OF THE DRAWINGS

Embodiments will now be described, by way of example only, with reference to the drawings, in which:

FIG. 1 is an illustration of an example port-based surgical approach. A port is inserted along the sulci to approach a tumor located deep in the brain.

FIG. 2 is an illustration of an example training model in an exploded view, illustrating parts of the base component and the training component.

FIG. 3 is an illustration of an example base component of the training model illustrating the tray, the head and the skull.

FIG. 4 is an illustration of an example base component of the training model without the skull section, illustrating fiducials that are important for registration of images acquired using different modalities.

FIG. 5 is an illustration of an example base component of the training model, shown containing the training component.

FIG. 6 is an illustration providing a detail view of an example training component, illustrating various clinically relevant example components that may be emulated in the model.

FIG. 7 is an image shown an example model of a mammalian brain that is contained within the training component. This model illustrates the sulci and the lobes of the brain.

FIGS. 8A and 8B show photographs of different example embodiments of the training model, illustrating the base component and the brain component. Facial features are not shown in this example implementation of the base component.

FIG. 9 shows a display presenting MR images of an example brain phantom, illustrating visibility of surface structures (sulci), embedded target tumor and fiducials.

FIG. 10 is a CT image obtained using the same training model illustrating the brain region and embedded tumors.

FIG. 11 shows a 3D reconstruction of the CT image, illustrating reference markers or fiducials and surface structures (sulci).

FIG. 12 shows the use of MR images acquired at the time of manufacturing (left portion of the figure) for fine tuning data acquisition protocols and parameters in an iterative manner. The improvement is achieved using an effectiveness measure or metric.

FIG. 13 shows a picture of a brain phantom produced in accordance with the methods disclosed herein.

FIG. 14 shows a diffusion image acquired with MRI in which the grid is a reconstruction of the fiber tracts within the image.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. In one non-limiting example, the terms “about” and “approximately” mean plus or minus 10 percent or less.

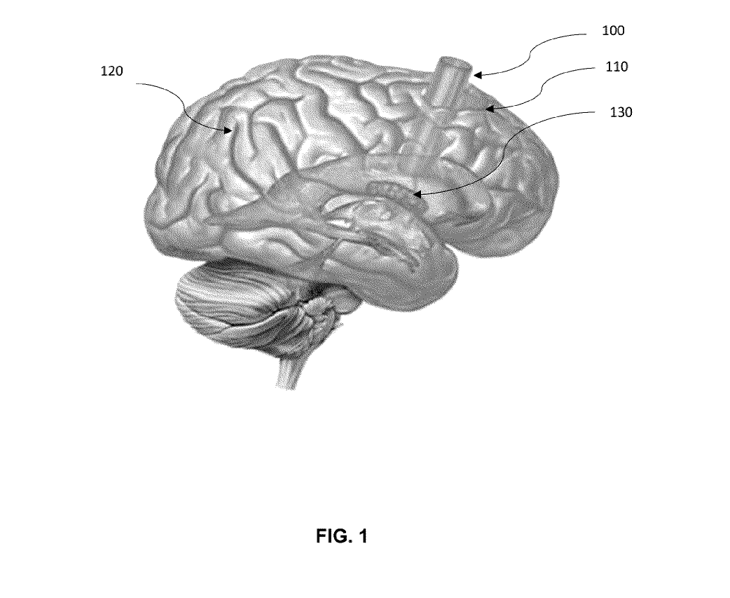

When performing surgical and/or diagnostic procedures that involve the brain, neurosurgical techniques such as a craniotomy, or a minimally invasive procedure such as an endo-nasal surgery or a port based surgical method, may be performed to provide access to the brain. In such procedures, as indicated, the medical procedure is invasive of the mammalian head. For example, in the port-based surgical method illustrated in FIG. 1, a port (100) is inserted along the sulci (110) of the brain (120) to access a tumor (130) located deep in the brain.

According to embodiments provided herein, the simulation of such procedures may be achieved by providing a brain model that is suitable for simulating the surgical procedure through one or more layers of the head. Such a procedure may involve perforating, drilling, boring, punching, piercing, or any other suitable methods, as necessary for an endo-nasal, port-based, or traditional craniotomy approach. For example, some embodiments of the present disclosure provide brain models comprising an artificial skull layer that is suitable for simulating the process of penetrating a mammalian skull. As described in further detail below, once the skull layer is penetrated, the medical procedure to be simulated using the training model may include further steps in the diagnosis and/or treatment of various medical conditions. Such conditions may involve normally occurring structures, aberrant or anomalous structures, and/or anatomical features underlying the skull and possibly embedded within the brain material.

In some example embodiments, the brain model is suitable for simulating a medical procedure involving a brain tumor that has been selected for resection. In such an example embodiment, the brain model is comprised of a brain material having a simulated brain tumor provided therein. This brain material simulates, mimics, or imitates at least a portion of the brain at which the medical procedure is directed or focused.

The simulation of the above described medical procedure is achieved through simulation of both the surgical procedure and the associated imaging steps that are performed prior to surgery (pre-operative imaging) and during surgery (intra-operative imaging). Pre-operative imaging simulation is used to train surgical teams on co-registration of images obtained through more than one imaging methodology such as MR, CT and PET. Appropriate co-registration geometrically aligns images from different modalities and, hence, aids in surgical planning step where affected regions in the human body are identified and suitable route to access the affected region is selected.

Another use of pre-operative imaging is to train the surgical team and radiologists on optimizing the imaging parameters so that clinically relevant images are acquired prior to the surgical procedure. For example, pre-operative MR images need to be acquired in a specific manner to ensure that the acquired data can be used to generate tractography information, such as Diffusion Tensor Imaging (DTI), which shows the location and direction of the brain tracks which are not visually observable by the surgeon. Intra-operative imaging is used to guide the surgeon through accurate surgical intervention while avoiding damaging the brain tracks if possible. Surgical intervention includes accessing a previously identified affected region in the human body and subsequent resection of affected tissue.

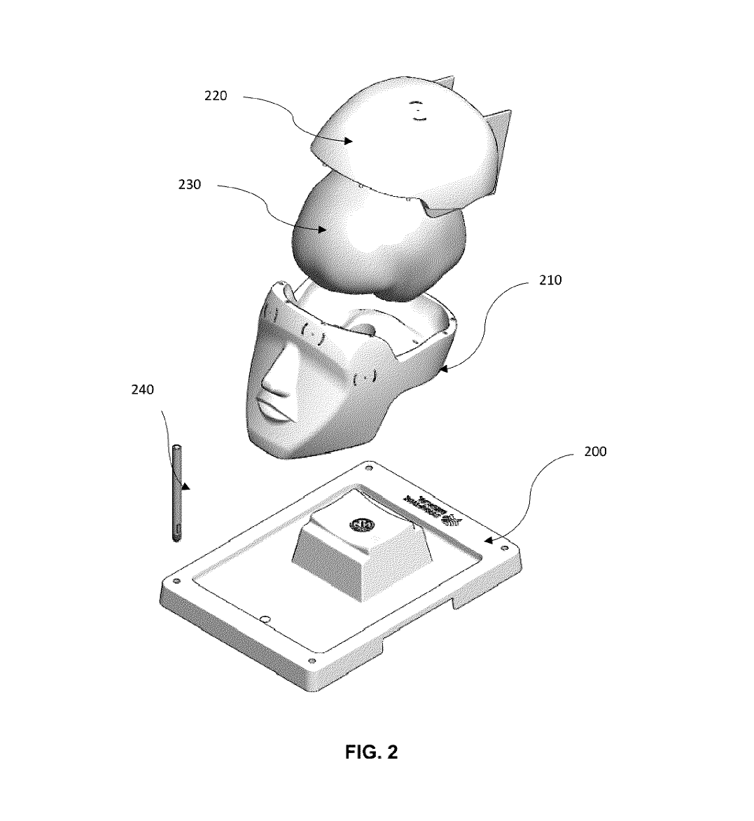

Referring to FIGS. 2-6, an exploded view of an example model or phantom shown generally at 100 is provided that is suitable for use in training or simulation of a medical procedure which is invasive of a mammalian head. The training model 100 may be adapted or designed to simulate any mammalian head or a portion thereof. It is to be understood that the person to be trained may be selected from a wide variety of roles, including, but not limited to, a medical doctor, resident, student, researcher, equipment technician, or other practitioner, professionals, or personnel. In other embodiments, the models provided herein may be employed in simulations involving the use of automated equipment, such as robotic surgical and/or diagnostic systems.

Referring now to FIG. 2, an exploded view of an example implementation of training model (100) is shown that includes a base component and a training component. The base component is comprised of a tray component (200) and a head component. The head component is comprised of a bowl component (210) and a skull component (220). The training component may be comprised of a brain (230) with the following layers: dura, CSF (cerebro spinal fluid), vessels, white matter, grey matter, fiber bundles or tracks, target tumors, or other anomalous structures. The training component may also include the aforementioned skull component (220) when crafted in a skull mimicking material. Optionally, the training model (100) may be also comprised of a covering skin layer (not shown). Further, the base component may include a holder (240) provided on the tray (200) to facilitate easy mounting of fiducials or reference points for navigation.

Referring to FIGS. 3-5, the tray component (200) forming part of the base component defines a training receptacle which includes a pedestal section (242) which is sized and configured for receipt of the bowl component (210) therein. Thus the training component is sized, configured or otherwise adapted to be compatible with, or complementary to the base component, and particularly the training component receptacle, such that the base component and the training component may be assembled to provide the assembled training model (100).

The base component may have any size, shape and configuration capable of maintaining the training component, mounted within the training component receptacle, in a position suitable for performing the medical procedure to be trained. This base component comprises features that enable registration, such as fiducials, touchpoint locations, and facial contours for 3D surface scanning, MR, CT, OCT, US, PET, optical registration or facial registration. Furthermore, the base component is adapted or configured to maintain the training component in a relatively stable or fixed position throughout the performance of the medical procedure to be simulated during the training procedure. The base component provides both mechanical support during the training procedure and aids in the proper orientation of the training components to mimic actual positioning of a patient's head during the surgical procedure.

Referring to FIGS. 2 and 3, as noted above, the base component may be comprised of a head component (210) and a tray component (200). The tray component (200) is sized, configured or otherwise adapted to be compatible with, or complementary to the head component (210). The tray component (200) is adapted or configured to maintain the head component (210) in a relatively stable or fixed position throughout the performance of the imaging or medical procedure to be simulated. This may be accomplished with the use of a mechanical feature such as a snap mechanism that exists to affix the head component (210) to the tray component (200). The tray component (200) may contain a trough (244) to catch liquids, and insertion points to affix hardware to aid with image registration and/or the medical procedure to be trained.

The head component (210) is sized, configured or otherwise adapted to be compatible with, or complementary to the tray component (200) and the training component. The head component (210) is adapted or configured to maintain the training component (230) (located under skull component 300) in a relatively stable or fixed position throughout the performance of the medical procedure to be simulated. This head component (210) is adapted or configured to enable anatomically correct surgical positioning. This may include affixing the head component (210) with a surgical skull clamp or headrest, for example a Mayfield skull clamp. This head component (210) is also adapted or configured to enable anatomically correct imaging positioning for any contemplated imaging modality including, but not limited to, MR, CT, OCT, US, PET, optical registration or facial registration. For example the head component (210) may be positioned in a supine position within an MRI apparatus to enable anatomically accurate coronal image acquisition.

In some embodiments, the head component (210) is shaped or configured to simulate a complete or full skull. In other words, the training component comprises bowl section (210) and skull section (220), while the bowl section (210) comprises a further portion of a complete skull and head. In some embodiments, as shown in FIG. 2, the head component i.e., bowl section (210) and skull section (220), and training component (230) together provide a complete simulated skull or together provide a simulated head including skull (220) and brain (230). The simulated head provided by the training model (100) enhances the reality of the overall simulation training experience.

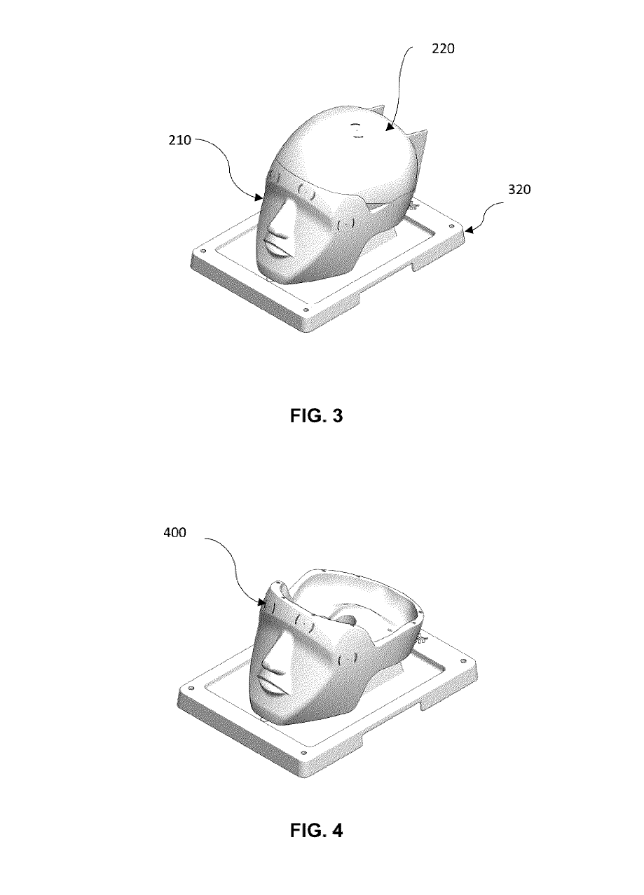

In addition, the base and training components of the training model (100), and particularly the head component, may also include one or more external anatomic landmarks or fiducial locations 400, as shown in FIG. 4, such as those likely to be relied upon by the medical practitioner for image registration for example, touchpoints, the orbital surface, nasal bone, middle nasal concha, inferior nasal concha, occipital bone, nape, and nasal passage. These features will aid in registering the training component with the preoperative images, such as MR, CT, OCT, US, PET, so that the surgical tools can be navigated appropriately.

In this regard, navigation to establish the location of the hole or passage through the skull of the patient during the craniotomy procedure is often critical for the success of the medical procedure. Accordingly, external anatomic landmarks and/or touchpoints are provided by the simulated head in order to provide training on the correct registration of the training model with the acquired images. These anatomic landmarks and touchpoints may be utilized for attaching registration hardware, for example a facial registration mask or fiducial landmark. Thus, the training model, and particularly the simulated head, are sized, configured and shaped to approximate and closely resemble the size, configuration and shape of the head of a patient on which the medical procedure is to be performed. In other words, the head component may be both ‘life-like’ and ‘life-sized’.

The base component may be comprised of any composition or material suitable for providing the training component receptacle, and may be suitable for being cast, molded or otherwise configured to provide or support the simulated head when assembled with the training component. For instance, the base component may be comprised of any suitable casting compound, casting composition or plaster. The base component may be comprised of a material that is rigid, non-reflective, non-ferrous, non-porous, cleanable, and lightweight, for example a urethane or acrylonitrile butadiene styrene (ABS). In addition, the bowl (210) and skull (220) components of the base component may be comprised of a material that is visible by the imaging procedure of interest to enable registration. The material for the bowl (210) and skull (220) components of the base may therefore be selected to be visible by MR, CT, and/or PET. Suitable properties for mimicking the skull component (220) for various imaging modalities are illustrated in Tables 1, 2 and 3.

In another embodiment, the base component may be manufactured from a material that is not visible in MR, CT and PET. This is particularly of value when the scope of training does not include facial registration and craniotomy. For example, it is widely known that Teflon™ may be chosen when the base component needs to be transparent in MRI. This further eliminates subsequent software processing steps where the skull structure of the head needs to be removed prior to visualizing the brain structure. This step is commonly known as skull stripping and it can be computationally costly.

The three simulation steps described previously (namely, pre-operative imaging simulation, surgical simulation and intra-operative imaging simulation) can be realized using models or phantoms that share some properties in common. Properties of tissue mimicking materials that are suitable for imaging using various modalities are presented next.

PET imaging requires the injection of radioactive contrast agent prior to the imaging step. The half-life of the contrast agents will limit the shelf-life of the training phantom. This can be overcome by manufacturing the phantom with micro-capillaries so that contrast agents can be introduced via the capillaries just prior to PET imaging. Alternatively, contrast agents may be injected to selected regions of the brain component.

Densities for Brain Mimicking for Imaging in CT and US

Physical properties of the brain that are preferred for CT and US imaging are illustrated in Table 1 (Barber, Ted W., Judith A. Brockway, and Lawrence S. Higgins. “The Density Of Tissues In And About The Head.” Acta Neurologica Scandinavica 46.1 (1970): 85-92. Web.).

TABLE 1
Properties suitable for CT and US imaging

| Human Brain | Density (g/cm\hat{ }3) |
|---|---|
| Frontal White | 1.073 |
| Frontal Gray | 1.090 |
| Parietal White | 1.026 |
| Parietal Gray | 1.109 |
| Occipital White | 1.073 |
| Occipital Gray | 1.103 |
| Corpus-callosum | 1.093 |
| Thalamus | 1.052 |
| Caudate Nucleus | 1.075 |
| Putamen | 1.081 |
| Global Pallidus | 1.084 |
| Brachium Pontis | 1.116 |
| Medulla | 1.057 |
| Pons | 1.069 |
| Cerebellum | 1.058 |

Optical Properties for Brain mimicking for imaging using OCT are presented in Table 2 (Cheong, W. f., S. a. Prahl, and A. j. Welch. “A Review of the Optical Properties of Biological Tissues.” IEEE Journal of Quantum Electronics 26.12 (1990): 2166-185. Web.).

TABLE 2
Properties of the brain that are preferred
for imaging using OCT.

| Brain | Transmission | Absorption | Scattering | |
|---|---|---|---|---|
| Matter | Coefficient | Coefficient | Coefficient | Wavelength |
| White | 52.6 | 1.58 | 51 | 633 |
| Grey | 62.8 | 2.63 | 60.2 | 633 |

Alternately, the properties of materials suitable for mimicking intra-operative ultrasound (i-US) may be established using operating frequency of typical ultrasound transducers.
(reference: http://www.bkmed.com/Intraoperative_US_en.htm).
For intra-operative US, frequency range is from 4 to 10 MHz. This is based on such instruments as BK medical transducers, intraoperative 8815, T-shaped intraoperative 8816, Intraoperative biplane 8814, Hockey Stick 8809, and the, Intraoperative biplane 8824. At 5 Mhz the average propagation speed through mixed tissue is 1565m/s. Another property of the tissue that is preferred for ultrasound imaging is attenuation coefficient. This is illustrated in Table 3.

### (Kremkau, Frederick W. “Ultrasonic Attenuation and Propagation Speed in Normal Human Brain.” The Journal of the Acoustical Society of America70.1 (1981): 29. Web.)

TABLE 3
Attenuation coefficients for 5 MHz frequency ultrasound
through the brain

| Brain Matter | Attenuation Coefficient |
|---|---|
| White Matter | ≈7 db/s |
| Grey Matter | ≈4 db/s |
| Mixed Matter | ≈3 db/s |

Parameters of the brain tissue that are essential for mimicking MR images are T1, T2, and Spin Densities. This is illustrated in Table 4 for various components of the brain.

TABLE 4
T1, T2 and spin densities of various parts of the brain

| | Relative | | | | |
|---|---|---|---|---|---|
| | Spin | 1.5T | | 3.0T | |
| Type of Matter | Densities | T1 (ms) | T2 (ms) | T1 (ms) | T2 (ms) |
| Gray Matter | 83 | 1000 | 100 (T2), | 1331 | 85 (T2) |
| | | | 65 (T2*) | | 42 (T2*) |
| White Matter | 71 | 710 | 80 (T2) | 4000 | 70 (T2) |
| | | | 78 (T2*) | | 49 (T2*) |
| Cerebral Spinal | 100 | 4000 | 2200 | 4000 | 2200 |
| Fluid | | | | | |
| Venous Blood | 82 | 1435 | 150 | 1584 | 80 |
| Arterial Blood | 82 | 1435 | 235 | 1664 | 165 |
| Fat | 90 | 300 | 165 | 380 | 133 |

Finally, PS-OCT is used to visualize birefringence property of living tissue. Birefringence is directionality dependent and would therefore vary quantitatively depending on the particular brain being imaged; however, the visually invisible brain tracts could be reproduced and optimized using a particular material that may be organized in such a way to give the desired brain tract orientation.

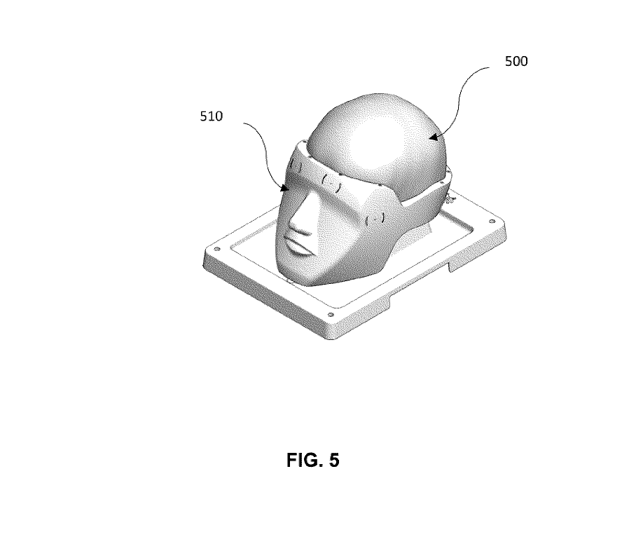

As shown in FIG. 5, the training component (230) and the base component (210) are complementary or compatible such that when the training component (230) is mounted on the pedestal (242) in the training component receptacle in tray (200), together they provide the training model. Furthermore, the configuration and dimensions of the training component (230) and the base component (210) are complimentary or compatible such that the training component (230) may be received and fixedly or releasably mounted in the base component (210).

In some embodiments, in order to permit the replacement or substitution of the training component (230), the training component is detachably or releasably mounted in the base component (210). Any detachable or releasable fastener or fastening mechanism may be used which is capable of securing the training component (230) in the receptacle, while also permitting the training component (230) to be readily detached, released or removed as desired or required. In one embodiment, the training component (230) is releasably or detachably mounted within the base component (210), specifically the training component is held within the base component (210) to emulate the mechanical fixation of the brain in the skull.

Thus, in the present example embodiment, the training component (230) may be removed from the base component (210) and replaced with an alternate, replacement or substitute training component as desired or required by the user of the training model. For instance, a replacement training component (230) may be required where the previous training component (230) is damaged or modified during the training of the procedure. An alternate training component (230) may be adapted or designed for use in the training of the performance of a specific medical procedure or condition of the patient, allowing for the reuse of the base component (210).

Alternatively, as indicated, the training model (100) may not include the base component (210). In this instance, the other components comprising the training model (100), such as the training component (230) in isolation, may be supported directly by a supporting structure or a support mechanism (not shown) that does not look like a mammalian head. Specifically, the supporting structure may securely maintain the training component (230), without the other components of the training model, in the desired orientation. In such an embodiment, the training component (230) may be releasably attached or fastened with the supporting structure such that the training component (230) may be removed from the supporting structure and replaced with an alternate, replacement or substitute training component (230) as desired or required by the user of the training model.

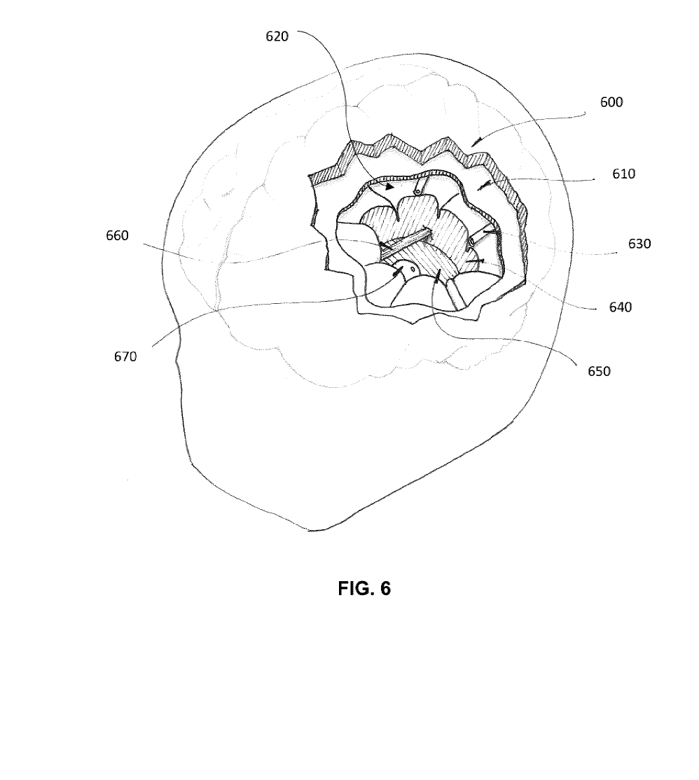

Referring to FIG. 6, the training component (230) may be comprised of a simulated mammalian head. The simulated head may be comprised of skull (220), dural layer (610) (or dura), CSF layer (620), blood vessels (630), a brain section including grey matter (640), white matter (650), diffusion or brain fibers (660), and a tumor target (670). This training component (230) may be customized as desired to train on the medical procedure of interest, for example the training component (230) may include all of these layers or a subset such as the dura (610), white matter (650), and tumor target (670).

In one embodiment, the skull layer (220) is included as an element of the training component (230). The skull layer (220) is formed from osseous type material as described herein. This skull layer (220) is constructed of a skull material which simulates osseous tissue when penetrated. Hence, this layer (220) is intended to simulate surgical resection. Thus, the skull material of the skull section (220) mimics or imitates osseous tissue when penetrated, pierced or passed into or through. In an embodiment described herein, the medical procedure is comprised of drilling into or through a portion of the skull, which is simulated by the skull section (600). In order for the skull section (220) of the present phantom to mimic or imitate osseous tissue, properties illustrated in Table 5 need to be met by the material simulating skull section (220).

TABLE 5
Properties of the Skull for surgical mimicking

| Property | Mean | |
|---|---|---|
| Skull Thickness | .272 | in |
| Diploe Thickness | .108 | in |
| Dry Weight Density | .051/in\hat{ }3 | |
| Modulus Compression Radial | 350000 | psi |
| Secondary Modulus Compression | 53000 | |
| Radial | | |
| Modulus compression | 810000 | |
| tangential direction | | |
| Poisson's ratio | 0.19 | |
| compression radial | | |
| Poisson's ratio | 0.22 | |
| compression tangential | | |
| Ultimate strength | 10700 | psi |
| compression radial | | |
| Ultimate strength | 14000 | psi |
| compression tangential | | |
| Ultimate strain | 97000 | in/in |
| compression radial | | |
| Ultimate strain | 0.051 | in/in |
| compression tangential | | |
| Energy absorption | 1200/\hat{ }3 | |
| compression radii | | |
| Energy absorption | 480/in\hat{ }3 | |
| compression tangential | | |
| Microhardness Vickers DPH | 31.6 | |
| inner table | | |
| Microhardness Vickers DPH | 34.2 | |
| outer table | | |
| Ultimate strength | 3100 | psi |
| diploe direct shear | | |
| Index of isotropy | 2.5 | |
| Ultimate strength | 3200 | psi |
| diploe torsion | | |
| Modulus torsion diploe | 200000 | psi |
| Ultimate strength | 6300 | psi |
| tension tangential | | |
| Modulus tension | 780000 | psi |
| composite psi | | |
| Ultimate strength | 11500 | psi |
| tension tangential | | |
| compact tables | | |

Thus, in such embodiments, the skull material particularly simulates, mimics or imitates the “feel” and resistance of osseous tissue when it is being penetrated by drilling. For example, the osseous tissue mimic may be formed from an acrylonitrile butadiene styrene (ABS) material texturized and patterned to resemble skull tissue. ABS is a terpolymer of acrylonitrile, butadiene and styrene and typical or usual compositions are about half styrene with the balance divided between butadiene and acrylonitrile. An advantage of using ABS material is that considerable compositional variation is possible, resulting in many different grades of acrylonitrile butadiene styrene with a range of properties so if material tuning is required to achieve the properties noted in Table 5 there are considerable options. In addition, many blends with other materials such as polyvinylchloride, polycarbonates and polysulfones may be used. Acrylonitrile butadiene styrene materials can be processed by any of the standard thermoplastic processing methods.

In addition, in order to more closely simulate the skull, the skull layer (220) may have a thickness which approximates that of the mammalian skull. In one embodiment, the skull layer (220) has a thickness which particularly approximates that of the portion or area of the neurocranium typically penetrated in performance of the medical procedure to be trained. Thus, the skull section of the training model, may have a total thickness in a range of about 5 to about 10 millimeters.

However, depending upon the medical procedure to be trained, the training model need not include the skull layer (220). Specifically, in some medical procedures, the medical procedure is directed at structures underlying the dural layer (610). In these instances, the emulation of the skull layer (220) is not critical. Thus the skull section (600) will not be required in the training model for that procedure. Further, as shown in FIG. 6, in some embodiments, a dural layer (610) may be provided which underlies the skull section (220). The dural layer (610) may be positioned to abut or lie adjacent to the innermost surface of the skull section (220). In other words, the dural layer (610) underlies the skull (600). The dural layer (610) material may be comprised of any material or substance capable of simulating dural tissue as described when applying surgical instruments or when imaged.

Thus, the dural material of the dura section (610) also mimics or imitates dural tissue visually, or when imaged with MR, CT, OCT, US, and/or PET, or when penetrated, pierced, stitched, or passed into or through. Thus, in the embodiments, as indicated above, the dural material particularly simulates, mimics or imitates the “feel” and resistance of dural tissue when it is being cut by a scalpel or surgical scissors. In some embodiments, the dural layer (610) also simulates the non-absorbent and liquid tightness exemplified by dural tissue. Thus creating a water-tight enclosure for the liquid surrounding the brain and preventing absorption of the CSF-type liquid used in the training model (230).

For instance, in some embodiments, the dural layer (610) material may be comprised of urethane or silicone brushed fibers. Although any suitable silicone or urethane may be used for the purpose of mimicking biomechanical properties of the dural layer (610), it may be beneficial to select a silicone or urethane that is opaque in nature, in order to obscure the view of the brain and its sulci below. Furthermore, it may be beneficial to select a silicon or urethane that forms or takes on the shape of the underlying sulci.

In addition, the biomechanical property of the dural layer (610) may be mimicked using a layer that may have a thickness which approximates that of the dura matter underlying the skull. In some embodiments, the dural layer (610) has a thickness which particularly approximates that of the dura mater underlying the inner portion or area of the neurocranium typically penetrated in performance of the medical procedure to be trained. In an embodiment, the dural layer (610) has a thickness of less than approximately 1 mm, for example, between about 0.5 to about 0.8 mm which is typical of the human dura.

Furthermore, as shown in FIG. 6, in some embodiments, a vessel layer (630) may be provided which underlies the dura section (610). The vessel layer (630) may abut or lie adjacent to the outermost surface of the brain section. The biomechanical property of the vessels may be simulated using material that may be comprised of any material or substance capable of simulating vessel tissue as described when applying surgical instruments or when imaged. Also, the vessel material of the vessel section (630) may also mimic or imitate vessel tissue visually, when imaged, for example with MR, CT, OCT, US, and/or PET or when penetrated, pierced, stitched, or passed into or through. Thus, in the embodiments, as indicated above, the vessel material particularly simulates, mimics or imitates the “feel” and resistance of vessel tissue when it is being cut by a scalpel or other surgical instruments. For instance, in some embodiments, the vessel layer (630) material may be comprised of a silicone material or a polyvinyl alcohol cryogel (PVA-C) mixture. This material is suitable for mimicking biomechanical properties and for producing appropriate MR and CT images. Biomechanical properties are mimicked through appropriate control of stiffness of the material using controlled cooling and heating cycles. Pigmentation may be applied to the vessel layer (630) material to represent a lifelike vessel coloring.

In addition, the vessel layer (630) may have a tubular shape with a diameter which approximates that of the vessels within the skull. In some embodiments, the vessel layer (630) is hollow to allow for the routing of fluids within, for example, a blood-like liquid mimic. In an embodiment, the vessel layer (630) has a thickness of between about 0.2 mm and 3 mm, and more preferably has a thickness of about 1 mm, a typical range for the human brain. Further, as shown in FIG. 6, in some embodiments, CSF layer (620) may be provided which underlies the dural layer (610). The CSF layer (620) may lie between the water-tight dural layer (610) and the non-liquid absorbent brain layer including grey matter layer (640), white matter layer (650), possibly surrounding the vessel layer (630), and within the brain ventricles if provided.

The CSF liquid in the CSF layer (620) may be comprised of any liquid or substance capable of simulating CSF as described when passing through or imaging the training component. Thus, the CSF liquid mimics or imitates CSF visually and when imaged, for example with MR, CT, OCT, US, and/or PET, or when passed into or through. Thus, in the embodiments, as indicated above, the CSF material in CSF layer (620) particularly simulates, mimics or imitates the “feel” and viscosity of CSF liquid when it is being passed through by surgical instruments. For instance, in some embodiments, the CSF liquid mimic may be comprised of a mineral oil or saline solution. The above stated CSF liquid mimicking material primarily simulates biomechanical property of the brain. In an embodiment, this liquid may be used to hydrate the fibrous structures included within the brain layer including grey matter layer (640), white matter layer (650).

In addition, the dural layer (610) may enclose a volume which approximates that of the CSF in the mammalian brain. In an embodiment, the CSF section (620) has a volume of between about 100 ml and 200 ml, such as, approximately 150 ml.

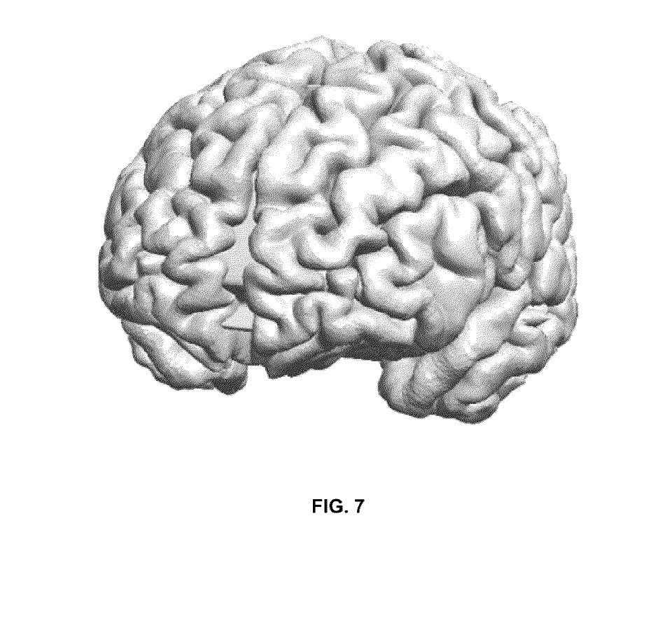

Further, as shown in FIGS. 6 and 7, a brain layer may be provided which underlies the dural layer and the skull section. Where both the dural layer and the brain layer are provided, the brain layer may abut or lie adjacent to the dural layer. In other words, the dural layer (610) is underlying the skull section, while the brain layer is underlying the dural layer (610). Thus, the dural layer (610) is interposed between the skull layer and the brain layer.

In some embodiments, the brain layer is constructed of brain layer material which simulates or mimics brain tissue, including grey matter layer (640) and white matter layer (650), when physically penetrated and/or when imaged, for example with MR, CT, OCT, US, and/or PET. As noted above, this brain layer may be divided into grey (640) and white matter (650) so that the brain layer material may be configured to mimic or imitate grey and white matter tissue when penetrated, pierced, or passed into or through and/or when imaged. For example, following the cutting or incising of the dura mater, the medical procedure may comprise penetration of the brain layer by inserting or passing surgical instruments, for example, a trocar, catheter, drain, port, obturator, Myriad™, into or through a portion of the brain. In such a case, the brain layer material mimic may have a composition that responds to these instruments in a manner that mimics that of real brain tissue, for example, the brain tissue will not clog up the Myriad™.

Thus, the brain layer material may particularly simulate, mimic and/or imitate the “feel” and resistance of brain tissue when it is being penetrated in this manner. However, the specific nature and composition of the grey and white matter (640) and (650) being penetrated may vary depending upon the particular medical condition of the patient and the procedure to be trained for. Accordingly, the grey and white matter material mimic (640) and (650) may be specifically selected to simulate, mimic or imitate the “feel” resistance, and imaging properties of the brain tissue likely to be encountered in the context of the patient's medical condition and the performance of the medical procedure being trained.

Accordingly, the brain layer mimic material may be comprised of any material or substance capable of simulating brain tissue as described. For instance, in some embodiments, the brain layer mimic material may be comprised of a polyurethane MCG-1 or PVA-C material. In an embodiment, the brain layer mimic material is comprised of a polyurethane material mixed with an additive such as glass bubbles or mineral oil to achieve the desired consistency of brain material.

In one example implementation, the brain layer material is comprised of a mixture of the polyurethane and glass bubbles. The glass bubbles may be incorporated so that they do not exceed 5% of the total volume, to mimic the tear strength and tensile properties of brain tissue. In another embodiment, the brain layer material mimic is comprised of 6% PVA-C mixed with water and one freeze-thaw cycle.

In some embodiments, the brain layer mimic material may have a thickness, dimensions, and anatomically accurate sulci and ventricles, which approximates the brain tissue likely to be encountered in the performance of the medical procedure to be trained. As indicated, in some medical procedures, the medical procedure is directed at the brain or structures lying within the brain. Thus the thickness of the brain layer mimic material will be selected to simulate the location within the brain, or the location of a structure within the brain, at which the medical procedure is directed.

Furthermore, as shown in FIG. 6, in some embodiments, fiber bundles or brain tracks (660) may be embedded within the brain matter layer mimic material. These fiber tracts (660) are intended to simulate the fiber tracts that are found within the brain matter, for instance the major white matter fiber tracts. The fiber bundles (660) may are positioned within the brain phantom to emulate the white matter tracts within brain tissue. The fiber bundles (660) may be comprised of any material or substance capable of simulating the mechanical and imaging characteristics of white matter fibers when imaged, for example with MR, CT, OCT, US, and/or PET. For instance, the fiber bundles (660) will embody the diffusion and mechanical properties of the white matter fibers when imaged with DWI and/or DTI or when applying surgical instruments. Thus, the white matter fibers (660) of the fiber section also mimics or imitates white matter fibers visually, when imaged, or when penetrated, pierced, stitched, or passed into or through. Thus, in the embodiments, as indicated above, the diffusion fibers (660) particularly simulate, mimic or imitate the “feel” and resistance of human brain diffusion fibers when it is being cut by a scalpel. Further, the diffusion fibers (660) provide a structured channel for water molecules to diffuse through. This structured diffusion results in the generation of diffusion tensor images (DTI) that resemble DTI obtained on living organs such as brain and heart. In some embodiments, the diffusion fibers (660) may be comprised of a fibrous structure within a sheath or tube, for instance polyester, nylon, poloypropelene or Dyneema® fibers packed within a plastic tube or heat-shrink. In another embodiment, the fibers (660) may be directly embedded within the white matter mimic material (650). The surrounding brain mimic material hydrates the fibers and provides the liquid that diffuses.

In addition, the diffusion fibers (660) may have a tubular shape with a diameter which approximates that of the white matter tracts within the brain section. In some embodiments, the diffusion fibers (660) are threaded through the brain matter mimic and protrude from the brain matter where they are exposed and hydrated by the surrounding CSF fluid mimic layer (620). This CSF fluid layer (620) provides the hydration which diffuses through the tubes and is visible in the acquired images. These diffusion fiber mimics (660) provide an enhanced training experience for the surgeon as during the training procedure they are encouraged to avoid tearing or harming the diffusion fibers during the operation.

Furthermore, as shown in FIG. 6, depending upon the specific medical procedure to be trained for, in some embodiment of the training model, a target may be provided which underlies the skull layer, and underlies the dural layer, within the brain layer material. However, the specific location of the target underlying the skull section may vary depending upon the nature of the target and the nature of the medical procedure to be trained which is directed at the target.

In general terms, the target is intended to simulate, mimic or imitate a specific structure embedded within the brain layer material which is the focus of the medical procedure to be trained or at which the medical procedure is directed. The specific structure or focus of the medical procedure may be normal or aberrant anatomical structure, clot, lesion, structure resulting from a pathological condition or other structure desired to be acted upon by the medical practitioner.

In one embodiment, the specific structure to be acted upon, or at which the medical procedure is directed, is a target tumor (670). This target tumor (670) may be comprised of any material or substance capable of simulating tumor tissue as described when applying surgical instruments or when imaged.

Thus, the target tumor (670) material mimics or imitates tumor tissue visually, when imaged, for example with MR, CT, OCT, US, and/or PET, or when penetrated, pierced, resected, or passed into or through. Thus, in the embodiments, as indicated above, the target tumor (670) material particularly simulates, mimics or imitates the “feel” and resistance of tumor tissue when it is being cut by a scalpel or Myriad^{TM}. For instance, in some embodiments, the target tumor (670) material may be comprised of a hydrocolloid material, a rubber-glass mixture, or a PVA-C mixture. These materials may be doped with contrast agents to simulate the imaging characteristics of tumor tissue. Exemplary, non limiting examples of contrast agents include any one of a fluoride, a chloride, or sulfate. Non-limiting examples include chromium fluoride, gadolinium chloride, copper sulfate, barium sulfate, manganese chloride. In addition, agarose may be used as well.

Hence, the simulated tumor (670) is suitable for mimicking biomechanical properties and for generating images that resemble tumor regions in living tissue. In an embodiment, pigmentation may be applied to the target tumor (670) material to represent a lifelike tumor coloring.

Referring to FIG. 6, in an embodiment, the target (such as, but not limited to tumor (670)) may be located or positioned a spaced distance from the innermost surface of the brain layer sulci (clearly visible in FIG. 7). In this instance, the brain layer is provided underlying the dural layer (610), wherein at least a portion of the brain layer is interposed between the dural layer (610) and the tumor target (670) in order to simulate the anomalous structure to be trained upon. Accordingly, the brain layer, or a portion thereof, will be required to be penetrated in order to access the tumor target (670). The specific location of the tumor target (670) within or underlying the brain layer will be selected to closely approximate the location of tumors within the human brain.

The imaging and biomechanical brain phantoms may be constructed to have specific dedicated sites, anywhere under the skull layer (220), sized to receive specifically sized target tumors (670) which match known types of tumors. The various parts of the brain phantom may have a modular construction, for example the skull (220), dura (610), CSF (620), vessels (630), brain section including grey matter (640), white matter (650), and diffusion fibers (660), may be constructed in a lego style so that sections can be readily removed to allow insertion of the target tumor (670) in pre-selected locations in the head below skull layer (220). The brain phantom kit disclosed herein may come with a plurality of different sized and shaped tumor targets (670) in order to be able to reconfigure the brain phantoms to allow training to be conducted for multiple types of tumors and multiple locations within the skull as well as for differently sized head phantoms emulating or mimicking differently aged patients.

In addition, one or both of the imaging and biomechanical phantoms may be constructed to include strategically placed sensors within the different anatomical mimics for the purpose of, but not limited to, assisting in navigation. The sensors may be coded for pre-selected locations in the brain phantom.

As noted elsewhere, to produce a lifelike brain phantom with biomechanical properties to allow a practitioner to train on various brain invasive surgical procedures, using the port based method involving insertion of the surgical port into the brain via the sulci, requires the model to be life size and with the deep sulci morphology.

An exemplary, non-limiting method of producing a one piece brain phantom including deep sulci includes acquiring an image of a human brain using MRI, using this image to 3D-print an anatomically accurate one piece model of the brain with deep sulci emulating the human brain. Once the model is produced, applying a flexible mold material to an outer surface of the model of the brain and after the mold material has set to form a brain mold, releasing the brain mold from the model of the brain. The brain mold is placed into a rigid outer shell to prevent swelling. The mold is filed with a liquid precursor of a brain material mimic. Depending on the ultimate purpose of the particular phantom being produced, there may be embedded in the liquid precursor one or more mimics for one or more structural brain features, such as a dural layer, blood vessel layer, and brain matter tracks to mention a few. The liquid precursor is then induced to set to form an anatomically correct brain phantom in one piece with deep sulci and after the liquid precursor has set, the set brain mold is released from the brain mold.

The gyri and sulci may be produced to exhibit any one or combination of elastic modulus, shear modulus, tensile strength and nonlinear elastic properties comparable to a mammalian sulci.

It is noted that the MR image used to make the model may be that of the patient to be operated on, so that the outer sulci morphology closely resembles that of the patient. Non patient specific, or generic brain phantoms may be produced for general training procedures, but the advantage of using the patient's brain phantom allows the practitioner to practise on a brain phantom closely matching that of the patient in question.

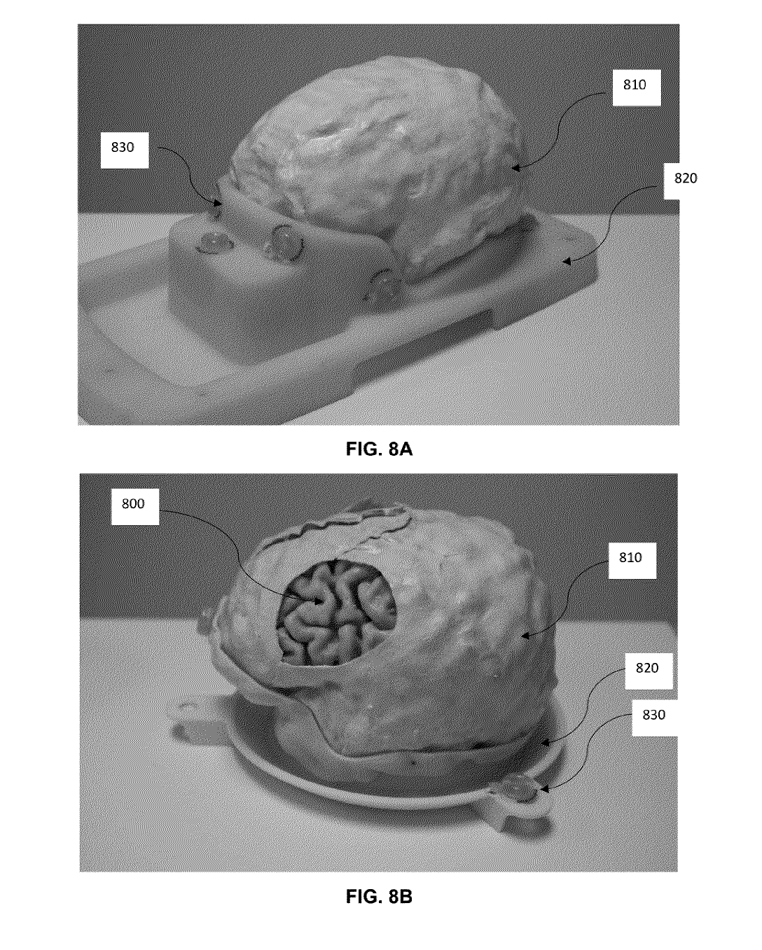

An example shape for the brain component of the training component is illustrated in FIG. 7 which as mentioned above shows the outer topography of the brain phantom. The shape is such that sulci and the two lobes are accurately represented. A manufactured example of the training model is illustrated in FIGS. 8A and 8B which shows the brain section (800) wrapped in the dura component (810) positioned on the base component (820) with fiducial or reference markers (830) placed at specific locations to facilitate image registration for surgical navigation.

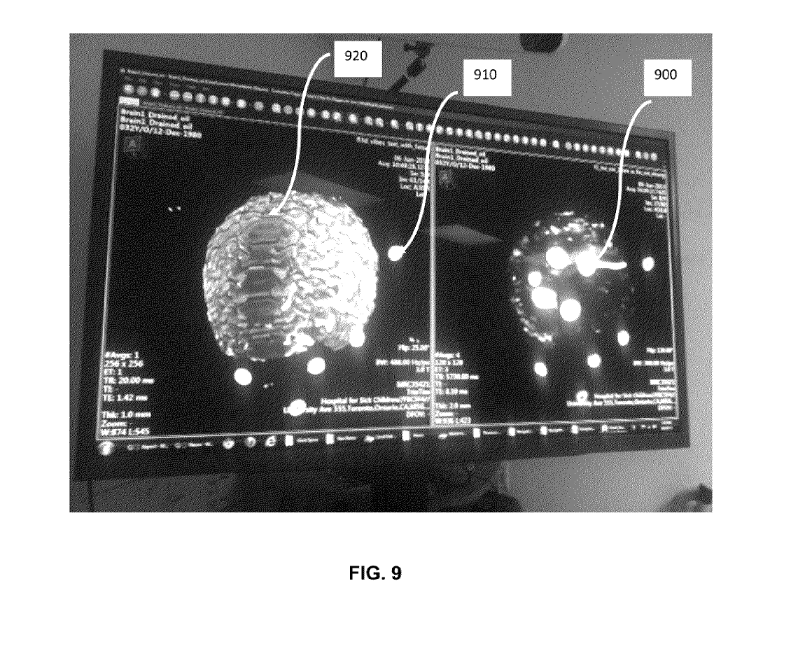

FIG. 9 illustrates the MR image obtained for this same training model or phantom shown in FIGS. 8A and 8B which was constructed using a polyurethane material as the brain matter mimic. As evident in the image, the surface profile (920), fiducials or reference (910) and the embedded tumors (900) are clearly visible in the acquired image.

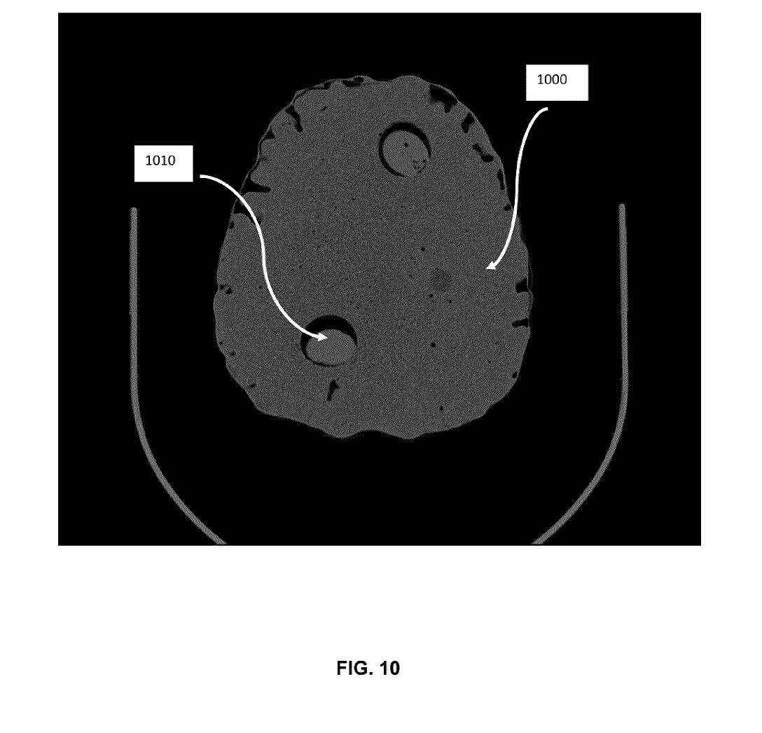

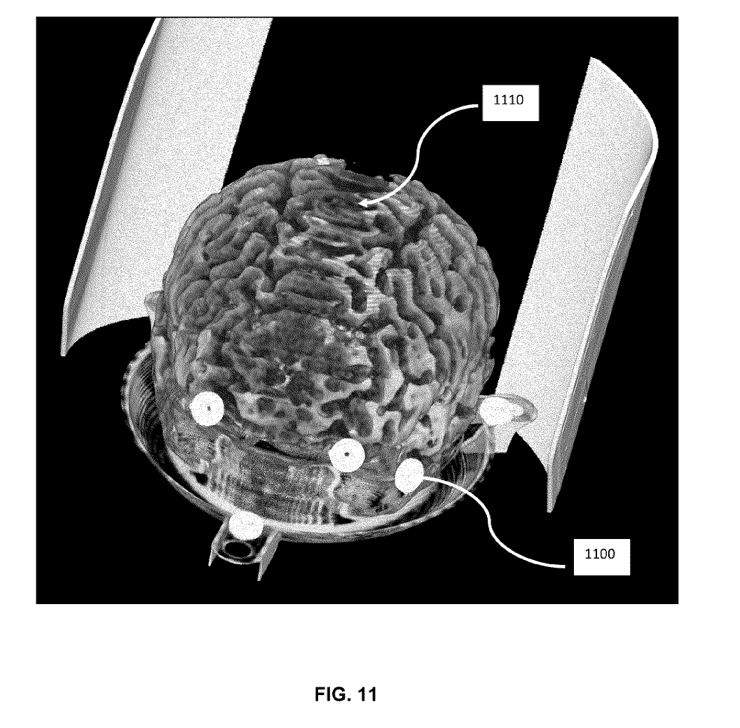

The CT image of the same training model is illustrated in FIG. 10, which is shown as a reconstructed 3D image in FIG. 11. These figures further illustrate the location of the tumor (1010) in the brain tissue (1000) seen in FIG. 10, the surface profile of the gray matter (1110) and location of fiducial or reference markers (1100), seen in FIG. 11. The visibility of fiducials (1100) in images acquired using multiple imaging modalities facilitates registration of different images and their subsequent using in image guided navigation during the surgical procedure described previously.

The tumor target may have any shape, configuration and dimensions, capable of and suitable for simulating, mimicking or imitating the specific structure underlying the skull of a patient which is the focus of the medical procedure to be trained on or at which the medical procedure is directed. An example size range may be from 1 mm to 3 cm, and the consistency may range from gelatinous to rigid. In one embodiment a tumor is made with a size of 1 cm of hydrocolloid material with a concentration of 0.2% copper sulfate as contrast agent. In another embodiment, rubber glass may be used as a tumor target with a rubber glass to slacker ratio of up to 1:4 or only composed of rubber glass, see:

http://www.smooth-on.com/tb/files/Slacker_Tactile_Mutator.pdf

In an embodiment, the training model or phantom may be provided with a simulated skin. Specifically, a skin layer may be provided for overlying at least the outer-most surface of the skull section. In other words, the skin layer overlies the skull section (230). In addition to overlying the skull section (230), which comprises the outer surface of the training component in some embodiments, a skin layer may also be provided for overlying all or a portion of the outer surface of the head component. Thus, for instance, the head component may include the skin layer in order to provide a more realistic simulation of the medical procedure.

The skin layer is constructed of a skin layer mimic material which simulates skin tissue when penetrated. Thus, the skin layer material mimics or imitates skin tissue when penetrated, pierced or passed into or through.

In an embodiment described herein, prior to penetrating the skull, the medical procedure may further require the penetration of the skin in order to provide access to the skull for the subsequent procedure. In this instance, the skin is typically cut or incised. Thus, in such embodiments, the skin layer material particularly simulates, mimics or imitates the “feel” and resistance of skin tissue being penetrated by cutting or incising.

The skin layer mimic material may be comprised of any material or substance capable of simulating skin tissue as described. For instance, in some embodiments, the skin layer mimic material is comprised of a silicone rubber or a flexible silicone elastomer. This material is intended to simulate biomechanical and imaging properties of living skin layer. Further, the skin layer material may provide a surface enabling image registration and/or facial registration, for example with MR, CT, US, and/or PET. In an embodiment, the skin layer material is comprised of a platinum cure silicone rubber which may be tinted with flesh colored dye or pigment, and which is commercially available under the name Dragon Skin, Dragon Skin is a trade-mark of Smooth-On Inc. This is suitable for mimicking the biomechanical and visual properties of the skin.

In addition, the skin layer may have a thickness which approximates that of the skin of the human head. In some embodiments, the skin layer has a thickness which particularly approximates that of the skin covering the portion or area of the neurocranium typically penetrated in performance of the medical procedure to be trained. In an embodiment, the skin layer has a thickness of about 2 millimeters.

In one embodiment of this training model, the imaging phantom and the biomechanical phantom are constructed independently however are identical in form and reference each other identically In other words, the imaging and biomechanical phantoms are anatomical analogues of each other or they are anatomically correlated. Therefore, the imaging phantom can be used for imaging purposes, for example with MR, CT, OCT, US, and/or PET. These images can be registered with the biomechanical phantom and used for navigation for the surgical procedure to be trained. In other words the imaging phantom and the biomechanical phantom both embody the characteristics of the training model, however the imaging phantom targets the imaging characteristics specifically and is directly correlated with the biomechanical phantom. While the biomechanical phantom embodies the biomechanical and physical characteristics of the phantom, for instance mimicking the tactile and tensile properties associated with the various layers within the training component.

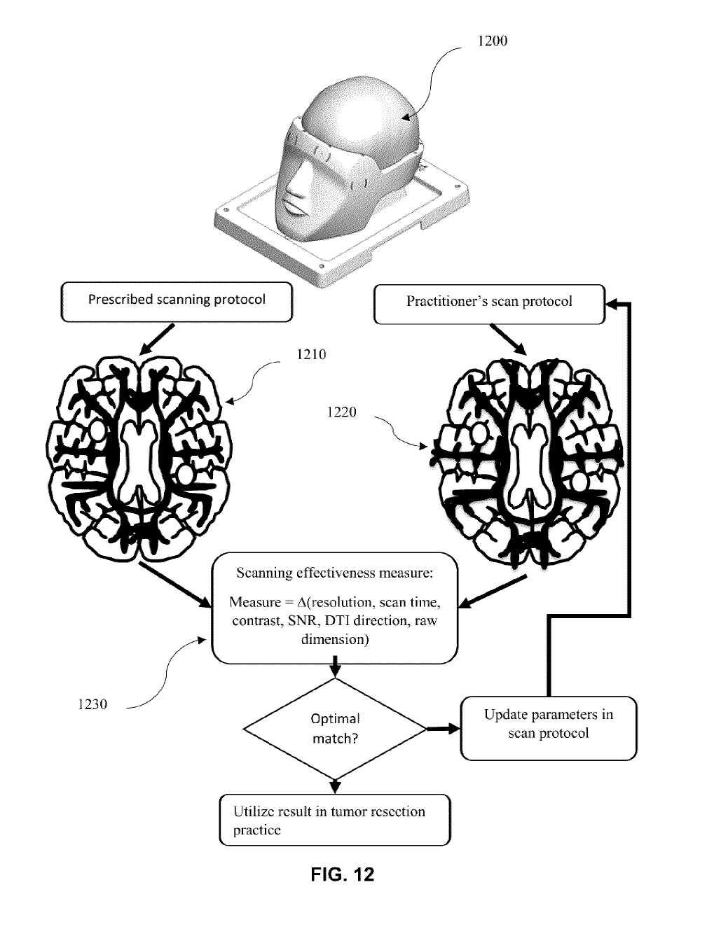

The above described independent construction of two phantoms that are identical in form and reference each other may be extended to more than two phantoms where third and subsequent phantoms may be constructed to be optimal for third and different imaging modalities. In one such embodiment, a quality assurance/control phantom is constructed which may be a deformable or non-deformable phantom that generates known and consistent Diffusion Tensor Images (DTI), so that these images are obtained with a phantom containing diffusion bundles (660) as shown in FIG. 6. This is illustrated in FIG. 12. A reference image (1210) acquired at the time of construction of the phantom may be included with the phantom so that imaging and surgical practitioners may iteratively improve their MR imaging protocols until the DTI output generated by the practitioners (1220) closely matches the DTI produced at the time of manufacturing. In other words, the phantom and its associated DTI, which may be stored on a CD or other medium, are shipped together to the end user as a brain phantom kit. Alternatively, the entity producing the brain phantom may keep the DTI stored at a location of its choosing but make it available online to the users of the brain phantom.

Provided along with the DTI are all the imaging parameters that were used to obtain the DTI so that the practitioner may reproduce these imaging parameters when they are practicing on the phantom. The quality control phantom will include known truths to be tested, such as being imaged with optimal pulse sequences that may be recorded and included with the phantom. For example, an optimal DTI scan may be used to image the diffusion fiber mimics whereupon at the practitioner's scanner, they can tune their diffusion sequence to optimize the pulse sequence for the practitioners scanner in order to recreate the quality control DTI sequence, knowing the reference level that they can and should achieve.

A software package containing appropriate algorithms may be used by the practitioner to run the analysis. For example, the practitioner scans the phantom and runs the analysis with the software analyzing the acquired image for quality and comparing it with the factory produced reference image. The software package is programmed with instructions to provide appropriate feedback to the practitioner, for example with respect to the resolution used by the practitioner, the feedback may be “your resolution is too low thus resulting in a noisy image, please try increasing your slice thickness to x”. Alternatively, if it is a research site they can use the quality control phantom to develop new pulse sequences knowing what they should achieve based on the quality control DTI sequence.

The software package may also contain appropriate algorithms programmed to analyze patient images for quality. For example, once an operator or technician performs a scan, the software may be programmed with algorithms to detect movement causing a reduction the quality of the image and then prompt the technician to repeat the scan given the artifact. If the artifact does not disappear, the operator/technician has the opportunity to scan the quality control phantom to try and troubleshoot the problem.

It is noted that pulse sequences are continually evolving, so that the software can be updated to reflect these new pulse sequences. For example due to continual improvements in MRI hardware, an optimal DTI scan today will unlikely be what is optimal is a year's time.

The development of optimal imaging parameters by the practitioner training on the phantom such as optimal MR pulse sequences may be further guided through the development of a scoring system (1230) that may be implemented as software or dedicated hardware. The scoring system (1230) will compare the MR image (1220) generated by the practitioner training on the phantom against the reference image (1210) generated at the time just after manufacturing the phantom where the latter image is considered to be the golden standard to the truth. Parameters for score may include aspects of the image that are relevant to development of optimal DTI output. Such parameters may include, but not are not limited to, resolution, scan time, contrast, signal-to-noise ratio, correct representation of direction of fiber bundles via DTI, raw dimensions of the acquired image etc. Hence, the imaging phantom teaches capture of optimal MR images with clinically useful DTI information that are of value for safely approaching and resecting tumor targets from the biomechanical phantom.

It will be understood that above described DTI phantom for qualification and optimization of data acquisition parameters need not be anatomically identical to a human organ such as brain or heart. Instead, it could be a fixed geometrical shape such as a sphere or a cylinder. Hence, total set or kit of training phantoms may include a brain-like biomechanical phantom, a brain-like imaging phantom and a third rigid phantom of fixed geometric shape for optimizing MR data acquisition parameters. Some of the hardware features of the phantom used to optimize MRI acquisition are illustrated in Table 6. These features may be compared with optimal values established a priori. Hence, the latter phantom can be used qualify acquisition protocols and used to perform root-cause analysis when failure of the MR equipment is suspected.

TABLE 6
Salient features of phantom used to qualify and optimize
MR data acquisition

| Hardware feature | Purpose |
|---|---|
| Geometrically shaped | Spherical or cylindrical shapes are |
| | easier to insert into standard MR |
| | bores. |
| Chambers with known T1 and T2 | Their values at varying field strengths |
| values | are known apriori. |
| Water chamber | To check water signal suppression |
| | functionality/determine water peak |
| | reference |
| Chamber with known contrast | To optimize MRI contrast level for |
| | T1, T2, T2* |
| Resolution plate with geometric | To establish x, y, z resolution |
| feature | (possibly curved, square, pyramid or |
| | combination) |
| Fits in head coil | Multiple size and shape variations of |
| | phantom for customization of various |
| | MRI machines |
| Has perfusion structures | To assure ability to detect signals at |
| | scales essential for effective brain |
| | imaging (ex. capillary scale) |
| Has diffusion fibers arranged in | To optimize and test DTI ability of |
| geometric formation | scanner. To determine effectiveness |
| | of DTI in multiple directions |
| Set area to measure SNR | To measure SNR |
| Material possible acrylic | MRI compatible material |
| Features to demonstrate correct | Features to line up with landmark |
| orientation in the magnet | |
| Pressure expansion screw for | To detect possible deformations of |
| shipping purpose | phantom caused by pressure |
| | changes during delivery |
| Temperature sensor | To plot temperature with respect to |
| | time during scan (using MRI |
| | compatible electronics). To |
| | determine instantaneous temperature |
| | of Machine |
| Choline chamber | For MRS optimization (correlates |
| | with cell density) |
| Built-in registration points | For registration with reference |
| | images |
| Ultrasmall super-paramagnetic iron | To optimize and determine detection |
| particles (USPIO) | sensitivity |
| Chambers with different nuclei | Possibly Carbon 13, Xenon 129 |
| Larmor frequencies | To optimize gradient and RF coils |

Some of the parameters analyzed using the latter phantom and their role are presented in Table 7. These parameters are intended to reduce the need for repeat scans for patients due to lack of insufficient data or quality in pre-operative scans, diagnostic scans, post-operative scans and functional MRI scans. The analysis result can be used to automatically deduce faults in the data acquisition process and suggest ways of improving the scans.

TABLE 7
Parameters analyzed for optimizing MR data acquisition
parameters using an MR phantom

| Parameter | Purpose |
|---|---|
| Completion status of protocol | To assure all tests are completed |
| Presence of area of interest | To test if F.O.V. is correct |
| Resolution [6] | To assure minimal resolution level is |
| | achieved |
| Contrast agent uptake (gadolinium) | To test detection and optimize |
| | imaging parameters with respect to |
| | contrast agent detection |
| Signal to noise ratio (SNR) [10] | To test detection and optimize |
| | imaging parameters with respect to |
| | SNR |
| CNR [5] | To test detection and optimize |
| | imaging parameters with respect to |
| | CNR |
| Confirm placement of fiducial | To test detector orientation |
| markers | output/warping of images/other |
| | factors |
| Checking for gating on/off | Assuring that gating is turned on |
| | when needed (example when |
| | imaging the heart), if gating is off |
| | when needed the software suggests |
| | it be turned on and vice versa |
| Check for presence of spikes in K- | All artefacts in test scans will be |
| space (image artefact check | detected using software and |
| Presence of motion artefacts | suggestions to improve the image will |
| Identify presence of wrapping | be provided. After implementation of |
| artefact | suggestions the image will be |
| Identify presence of ghosting | recaptured and the process will |
| artefact | |
| Identify flow artefact | repeat until artefacts are removed |
| Detect signal dropout | Use signal tracking |
| | software/reference signal to detect |
| | errors in signal |
| | acquisition/processesing and suggest |
| | alterations in imaging parameter to |
| | reduce artefacts |
| RF zippers | Detection of RF Zipper artefacts and |
| | removal thereof by suggestions to |
| | alter imaging parameters (caused by |
| | external interference from EM waves |
| | (i.e. electronic devices) with the RF |
| | suppression signal) |
| Gibbs ringing | Detection of ringing artefacts and |
| | removal thereof by suggestions to |
| | alter imaging parameters (caused by |
| | Gibbs phenomenon occurring when |
| | using the Fourier transform on the |
| | detected signal) |
| Chemical shift | Detection of ringing artefacts and |
| | removal thereof by suggestions to |
| | alter imaging parameters (caused by |
| | the machine mistaking a shift in |
| | frequency to be a shift in position |
| | which results in a ghosting effect |
| | around fat-organ boundaries) |
| Moire fringes | In MRI, the appearance of moire |
| | fringes can be caused by a variety of |
| | reasons e.g., inhomogeneity of the |
| | main magnetic field caused by a |
| | defect shielding (interference with RF |
| | pulses), interferences produced by |
| | aliasing, and interferences of echoes |
| | from different excitation modes (with |
| | different echo times). |
| Black boundary | Detection of black boundary artefacts |
| | and removal thereof by suggestions |
| | to alter imaging parameters (caused |
| | by choice of echo time which |
| | coincides with the phase shift |
| | between Fat and Water spins causing |
| | the 2 signals to cancel during |
| | detection) |

It will be understood that mammalian (human or animal) brain and head models disclosed herein may be employed for a wide variety of applications, for example, involving simulation, training, demonstration, education, research, and/or calibration of instruments and systems. In some example applications, embodiments provided herein may be employed for the simulation of medical procedures including brain tumor resection, deployment of deep brain stimulation devices, clot removal, craniotomy and installation of shunts. Furthermore, the procedures may be image guided where imaging modalities may include MR, DWI, CT, OCT, PET and ultrasound.

The above discussion has listed various materials that may be used for head and brain phantoms. The following give examples of imaging and biomechanical phantoms.

Example Imaging Phantom and Method of Making

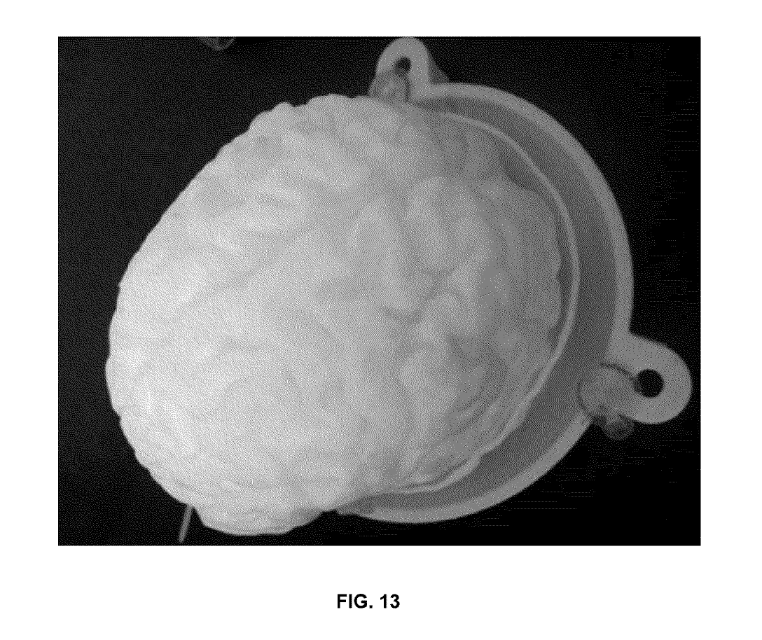

An image obtained through MRI was used to 3D-print an anatomically accurate shape of the brain with deep sulci emulating the human brain. While MRI was used in this example, it will be appreciated that images obtained using other modalities may also be used, including, but not limited to, MRI, CT, and PET. This brain was then used to form a mold by painting it with a flexible mold material such as a silicon plastic, rubbers, or latex. This mold was then released from the printed brain by scoring a large X on the underside of the brain, allowing the underside of the mold to be folded back to release the printed brain within. The flexible mold may then be used to mold an anatomically correct brain in one piece with deep sulci that may be released from the mold via the crosshairs on the underside. The brain material to be molded may by a firm or soft material, such as agar, gelatin, polyurethane, soybean gel, or a PVA formulation between 1 and 15% with between 1 and 8 freeze/thaw cycles. During the molding process, the brain mold is situated within a tough outer shell that prevents the mold from expanding during the process. A PVA hydrogel was constructed by emulsifying 4% PVA and 0.1% biocide in water. This formulation was poured into the mold and processed with 2 freeze/thaw cycles to achieve the appropriate biomechanical properties of the brain. FIG. 13 shows a picture of the brain phantom produced this way.

As discussed previously, this brain phantom may contain targets for resection, such as for example tumor targets, blood clots, abnormal anatomical features and the like. These targets are designed to emulate the biomechanical and imaging (MRI, CT, US) properties of the particular target(s). For example, in the case of brain tumors, ICH/Abscess, Metastatic/Cavernoma, High grade glioma, or low grade glioma mimics are provided. These targets are shaped by forming a mold with a size approximating a lesion, from 0.1 cm to 5 cm. This mold may be spherical in nature or erratically shaped as brain lesions may be. These molds may also contain leads which serve to tether the tumor within the brain. For example, one target may model a 3 cm metastatic tumor in the frontal-left portion of the brain, 2-4 cm from the surface of the sulci. These tumors are formed from between 1-15% PVA concentration dissolved in water and sent through between 1 and 8 freeze/thaw cycles to achieve the desired biomechanical and imaging properties. The targets may be situated within the brain phantom using a series of intersecting wires for support. These wires serve to position and suspend the targets in desired and repeatable locations. The tumor target(s) are positioned on the wires prior to pouring the brain formulation precursor within. Once the mold has set, the wires are pulled out from the mold and the targets remain within.

The imaging phantom will be composed of the same PVA-C concentration as the resection phantom, although enclosed in a skull for preservation as this imaging phantom is non-disposable. This imaging phantom may contain other brain features that are not present within the resection (biomechanical) phantom and do not disrupt the relationship between the two phantoms. For example, a target within the imaging brain phantom will correspond directly to the target within the resection or biomechanical phantom. Although, it will be understood that the imaging phantom may be produced to differentiate white matter from gray matter, contain a cerebellum, ventricles, CSF, and diffusion fibers. The gray matter layer may be over-molded on the white matter layer and both may be comprised of a PVA-C hydrogel mixture of between 2% and 8% with one or more freeze/thaw cycles and doped with appropriate concentrations of a suitable contrast agent to achieve the T1, T2, and T2* properties of the human brain. This will be achieve by mixing the appropriate chemical into the PVA formulation a suitable material. As noted above, these contrast agents may be any one of a fluoride, a chloride, or sulfate. Non-limiting examples include chromium fluoride, gadolinium chloride, copper sulfate, barium sulfate, manganese chloride. In addition, agarose may be used as well.

Diffusion fibers or fiber bundle mimics may be constructed by arranging and immersing strands of wicking material such as thread, twine, cloth, or rope within a hydrogel. The phantoms maybe produced replicating various fractional anisotropy (FA) and apparent diffusion coefficient (ADC) characteristics. Fractional anisotropy (FA) is a scalar constant with a value between zero and one that indicates the strength of directionality, where zero is isotropic and one indicates strong diffusion in only one direction. The apparent diffusion coefficient (ADC), indicates how diffusive the fiber is, where a large value indicates lots of diffusion and a low value indicates very little.

Within the diffusion phantom, these ADC and FA values are achieved by varying fiber parameters, such as the material of the fibers, diameter of the fibers (0.001mm-5 mm), and the amount of fibers within a bunch or rope formation. Fiber organization may include individual threads or tube like structures, these may be braided or bunched. Sample fiber materials include wire, organic, and/or synthetic fibers, for instance nylon, cotton, polyester, polyethylene, animal hair, wool, silk, teflon, bamboo, rayon, fiberglass, silica and microfibers. These fibers may be coated in a material such as wax which will also determine the FA and ADC properties of the diffusion.

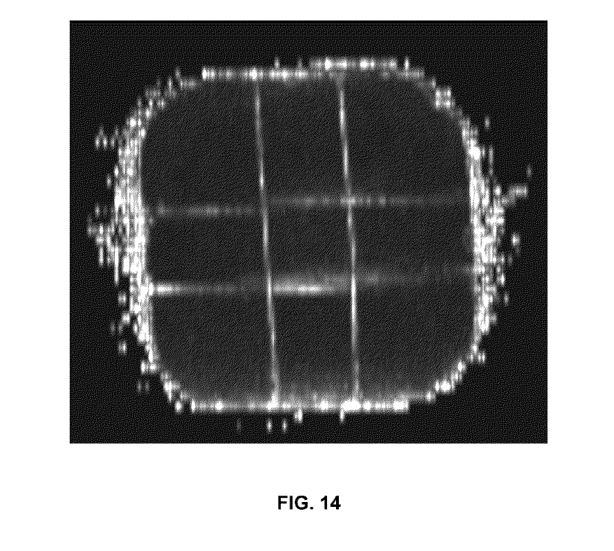

These strands may be individual or formed together in a bundle. The individual strand or bundle may be less than 5 mm in diameter or be thinner to approximate the diameter of fiber tracts within the human brain. These fibers may be constructed from material such as wood, bamboo, silk, polypropylene, or nylon. The hydrogel serves to hydrate while the wicking and fibrous nature of the strand provides direction. These fibers may be arranged to emulate the pattern of diffusion fibers or tracks within the brain. Alternatively, these fibers may be arranged within a quality assurance or quality control phantom to develop diffusion pulse sequences, or alternatively to assess the quality of imaging. A diffusion tensor image phantom was constructed from a 4 mm diameter nylon kernmantle rope that has been suspended in a grid formation within a plastic container. This container was then filled with a hydrogel formed from 8% PVA that was processed with two freeze-thaw cycles. A diffusion weighted image (DWI) was acquired with this phantom and is included in FIG. 14. The grid seen is that formed by the diffusion fiber mimics within the phantom.

Alternatively, diffusion fibers or fiber bundle mimics may be constructed by immersing strands of the wicking material within a tube filled with water and sealed. For example, a nylon kernmantle rope with a diameter of 4 mm is threaded through a Teflon tube with a 6 mm diameter, filled with water and then sealed with a heat sealing plastic. These fibers, when immersed within an imaging liquid, such as a PVA hydrogel, can be used to replicate the diffusion fibers or diffusion tracks within the brain or alternatively to calibrate or qualify diffusion weighted imaging scans with MRI.

While the preceding disclosure relates to a brain phantom exhibiting both imaging properties and biomechanical properties (either in a single phantom or in a pair of phantoms in which one is specifically optimized for use as an imaging phantom and the other is optimized for use as a biomechanical phantom), it will be appreciated that the same principles above may be applied to produce phantoms of other anatomical parts, organs, joints, spine, etc. Mimic materials are chosen to give imaging properties and biomechanical properties which closely mimic the actual anatomical parts based on the same principles as disclosed above for the brain phantom or brain simulator.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A complimentary head phantom kit, comprising:
a) a first imaging head phantom including mammalian brain anatomical mimics constructed of materials selected on the basis of being imageable with one or more imaging technique;
b) at least a second biomechanical head phantom including mammalian brain anatomical mimics constructed of one or more materials selected on the basis that said one or more materials mimic one or more biomechanical properties of a mammalian head; and
c) said first imaging head phantom and said at least a second biomechanical head phantom being registered together, wherein one or more acquired images taken of said first imaging head phantom using said at least one imaging technique are registered with said at least a second biomechanical phantom, by ensuring that features in the one or more acquired images from the imaging phantom are geometrically correlated to corresponding features in the biomechanical head phantom, for providing navigation of said second biomechanical head phantom during surgical training procedures.

2. The complimentary head phantom kit according to claim 1 wherein said first imaging phantom and said at least second biomechanical head phantom each include a tray portion, a head phantom component and a brain phantom component, wherein said head phantom component includes a face phantom component attached to a bowl component, said bowl component having a size and shape configured receive therein said brain phantom component, said head component including a skull phantom component having a size and shape to cover said brain phantom component, and wherein said tray is configured to releasably hold said head phantom component.

3. The complimentary head phantom kit according to claim 1 wherein said features in said imaging phantom and said corresponding features in said biomechanical phantom include any one or combination of identifiable structural features located on an exterior of said imaging phantom and said biomechanical phantom.

4. (canceled)

5. The complimentary head phantom kit according to claim 1 wherein said imaging phantom and said at least a second biomechanical head phantom include human brain anatomical mimics, including a skull mimic layer, a dura mimic layer, a cerebro spinal fluid mimic layer, a blood vessel mimic layer, a brain section mimic including a grey matter section mimic and a white matter section mimic, diffusion fibers mimic, and wherein all said mimics are generally are have a size, shape and location with respect to each other to form a human brain mimic.

6. The complimentary head phantom kit according to claim 5 wherein said mammalian brain mimic includes one or more brain tumor mimics located therein, said one or more brain tumor mimics representing one type of tumor when only one tumor mimic is present, multiple tumors of the same type when more than one tumor mimic is present or multiple tumors of different types when more than one tumor mimic is present.

7. The complimentary head phantom kit according to claim 5 wherein said at least a second biomechanical head phantom includes an outer skin mimic layer located over said skull mimic layer selected of a material selected to mimic or imitate a “feel” and resistance of mammalian skin tissue being penetrated by cutting or incising.

8-9. (canceled)

10. The complimentary head phantom kit according to claim 2 each of said imaging phantom and said biomechanical phantom include one or more fiducials strategically placed for enabling image registration and/or facial registration.

11. The complimentary head phantom kit according to claim 10 wherein said one or more fiducials are mounted
a) in one or more positions on said tray,
b) in one or more positions on said head phantom, and
c) any combination of a) and b).

12. The complimentary head phantom kit according to claim 7 wherein said outer skin mimic layer is provided with one or more fiducials strategically placed for enabling image registration and/or facial registration.

13. (canceled)

14. The complimentary head phantom kit according to claim 5 wherein said cerebro spinal fluid mimic layer includes a liquid having a viscosity selected to mimic a “feel” and viscosity of cerebro spinal fluid liquid when it is being passed through by surgical instruments.

15-21. (canceled)

22. The complimentary head phantom kit according to claim 5 wherein said brain section mimic is comprised of any one or combination of a polyurethane MCG-1 and PVA-C material.

23-42. (canceled)

43. A method of producing a brain phantom including deep sulci, comprising:
acquiring an image of a human brain;
using said image to 3D-print an anatomically accurate model of the brain with deep sulci emulating the human brain;
applying a flexible mold material to an outer surface of the model of the brain and after the mold material has set to form a brain mold, releasing the brain mold from the model of the brain;
placing the brain mold into a rigid outer shell and filing the mold with a liquid precursor of a brain material mimic, optionally embedding in the liquid precursor one or more mimics for one or more structural brain features;
inducing the liquid precursor to set to form an anatomically correct brain phantom in one piece with deep sulci; and
releasing the brain phantom from the brain mold.

44-45. (canceled)

46. The method according to claim 43 wherein the brain material mimic is a composite material including polyurethane and an additive present in an amount to give a pre-selected consistency of said brain section mimic.

47-49. (canceled)

50. The method according to claim 43 wherein the brain mimic material is a polyvinyl alcohol (PVA) formulation between 4 and 8%, and wherein the step of inducing the brain material mimic to set includes subjecting the polyvinyl alcohol (PVA) formulation to between 1 to about 8 freeze/thaw cycles.

51. (canceled)

52. The method according to claim 43 wherein the step of filing the mold with a liquid precursor of a brain material mimic includes mixing in a contrast agent present in an amount to give desired adjust T1 and/or T2 properties of the resulting brain mimic.

53-54. (canceled)

55. The method according to claim 43 wherein the step of embedding in the liquid precursor one or more mimics for one or more structural brain features includes embedding any one or both of a diffusion fiber mimic and bundles of said diffusion fiber mimic, and wherein said any one or both of fiber fibers and diffusion fiber bundles are positioned within said brain section mimic to emulate white matter tracts within human brain tissue.

56-60. (canceled)

61. The method according to claim 43 including, post release of a specific brain phantom from the brain mold,
acquiring one or more reference magnetic resonance images (MRI) of said specific brain phantom, and
storing said one or more reference MRI images in an accessible storage media and labeling said one or more magnetic resonance images as being associated with the specific brain phantom so that said one or more reference magnetic resonance images and imaging parameters are accessible by a practitioner during training.

62. The method according to claim 43 including, post release of a specific brain phantom from the brain mold,
acquiring one or more reference magnetic resonance images (MRI) of said specific brain phantom,
generating from said reference MRI images one or more reference Diffusion Tensor Images, and
storing said one or more Diffusion Tensor Images along with imaging parameters used to obtain said reference MRI images in an accessible storage media and labeling said one or more Diffusion Tensor Images as being associated with the specific brain phantom so that said one or more reference Diffusion Tensor Images and imaging parameters are accessible by a practitioner during training.

63. A method for acquiring MR images suitable to produce diffusion tensor images by a practitioner training on an imaging brain phantom produced according to the method of claim 62, comprising:
iteratively improving one or more diffusion tensor images acquired by a practitioner using the imaging phantom to match the one or more reference diffusion tensor images by computing a metric that incorporates MRI parameters that are used for acquiring MR images required for generating optimal diffusion tensor images; and
based on the computed metric, adjusting one or more of the parameters to improve the one or more acquired diffusion tensor images.

64. The method according to claim 63, wherein said MRI parameters are any one or combination of resolution, scan time, contrast, signal-to-noise ratio, correct representation of direction of fiber bundles via diffusion tensor images, raw dimensions of the one or more acquired images.

65-76. (canceled)
